(19) United States
(12) Patent Application Publication
(10) Pub. No.: US 2008/0040214 A1
(43) Pub. Date: Feb. 14, 2008

(54) System and method for subsidizing payment transaction costs through online advertising

(75) Inventors: Alfred Kahn, Denver, CO (US); David S. Johnson, Denver, CO (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: IP Commerce

(21) Appl. No.: 11/501,700

(22) Filed: Aug. 10, 2006

(51) Int. Cl. G06Q 30/00

(52) U.S. Cl. 705/14

(57) ABSTRACT

The present invention is directed to a services network integrating a system and method for subsidizing payment transaction costs through online advertising. Participants in the service network may subsidize the payment transaction costs of end-users through the activation of other services by the end-user in the service network.

### BACKGROUND OF THE INVENTION

1. Field of the Invention

The present invention relates to a system and method for subsidizing payment transaction costs through online advertising, and more particularly, to a system and method for providing rebates to merchants and other users of electronic payment processing services within a payment services network.

2. Discussion of the Related Art

Payment networks have become ubiquitous with today's business operators and merchants. A payment represents the final and successful culmination of any activity between consumers and/or businesses. Put another way, payment is the final step in a series of transactional communications or activities. Increasingly, these intermediate activities are conducted automatically over broadband connectivity and are mediated using software applications. The most basic example of this is the home computer user who orders and pays for a product from an eCommerce Website through a DSL or other Internet connection.

The electronic payments industry has traditionally relied on credit cards as the primary engine for growth. However, new forms of payment services are developing and are becoming more commonplace with consumers. Accordingly, merchants and businesses are required to accommodate an ever increasing variety of payment services to support their business. Consumers who increasingly have access to unique financing terms for each individual purchase transaction, view payment options holistically and do not make decisions based on how products have been compartmentalized by their providers.

While card associations seek to improve the revenue for their bank members and publicly justify the fee increases associated with these premium product offerings, merchants are mounting pressure on the fixed pricing system that subsidizes card rewards programs.

Despite the challenges facing today's payments systems, the number of businesses accepting electronic payments has doubled in just 5 years to approximately 6 million. This torrent of customer demand is currently funneled into an economy in which identical functions are provided by hundreds of players with systems which are unable to communicate with one another. Inefficiencies in today's payment systems result in effective transaction rates that would be hard to accept in any other realm of business. These inefficiencies give rise to unpleasant, and initially unintended, conditions: lack of visibility, universally prohibitive barriers to entry and churn.

The high effective transaction rates have prevented the payment process itself from being described to the general market. High fees that may not be perceived as having a favorable price-to-cost ratio are typically left in a black box, shrouded in mystery. Few electronic payment users, on the buy or acquire side, have any understanding of how the process actually works. As the variety of payment options increase so to do the processing fees and the variety of ways in which fees are assessed.

Payment options for consumers may be limited in some cases due to the processing fees associated with a particular type of payment service. Merchants must make extremely difficult decisions regarding the forms of payment they can afford to offer, thus balancing the costs associated with processing fees and the possibility that customers preferring a particular type of payment option my limit or avoid purchases with merchants not offering a particular type of payment option.

These and other deficiencies exist in conventional payment processing networks. Therefore, a solution to these and other problems is needed providing a payment processing system and methods for reducing the costs associated with the variety of payment processing options.

### SUMMARY OF THE INVENTION

Accordingly, the present invention is directed to a services network and method for subsidizing payment transaction costs through online advertising. The present invention resides within a payments network and provides incentives to merchants and other users of electronic payment processing services that use additional service advertised by the electronic payment processing services provider.

The payment network containing the subsidizing system of the present invention provides access to a third-party online advertising network within a payment processing entity. The advertising network provides access to opt-in services available to merchants while they are logged in to review their transaction reporting metrics. A merchant may navigate to additional information regarding the available programs and opportunities. The programs and services offered provide various opportunities for the merchant to lower their transaction costs with the electronic payment processing services provider. Merchants opting in to a service are then provided payment fee rebates or other reductions in their payment service fees. In turn, the third-party online advertising network provides compensation to the electronic payment processing services provider for the fee reductions given to the merchant.

It is to be understood that both the foregoing general description and the detailed description provided below and in the appendices are exemplary and explanatory and are intended to provide further explanation of the invention as claimed but not to narrow the invention.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a system view of a payment network, according to an embodiment of the present invention; and

FIG. 2 shows a method for subsidizing payment transaction costs through online advertising, according to an embodiment of the present invention.

### DETAILED DESCRIPTION OF VARIOUS EMBODIMENTS

Reference will now be made in detail to various embodiments of the present invention, examples of which are illustrated in the accompanying drawings. In general, the present invention is directed to a payment services network and method for providing payment transaction cost subsidies through online advertising.

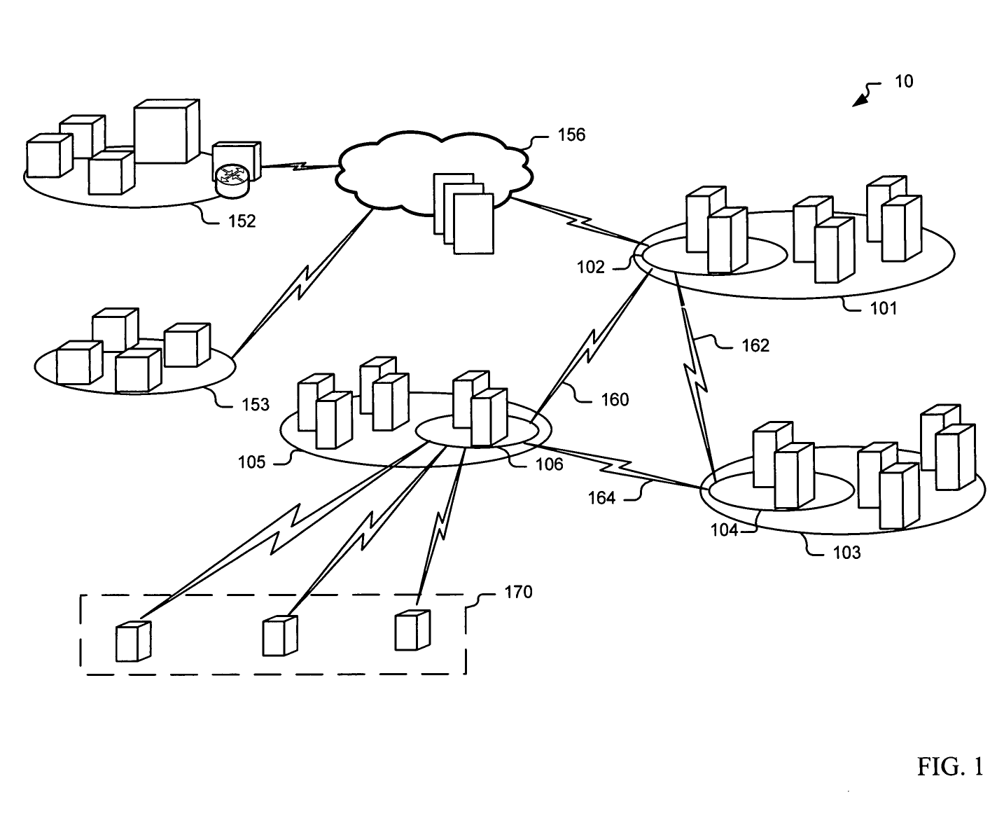

FIG. 1 shows a system view of a payment services network, according to an embodiment of the present invention. In FIG. 1 the payment services network 10 incorporates various instances of IP payments platforms 102, 104, and 106 within various participant networks 101, 103, and 105, such as banks, payment processors, or retailers, for example. For explanatory purposes participant network 101 will be referred to as a banking network, participant network 103 will be referred to as a payment processor network, and participant network 105 will be referred to as a retailer network.

According to an embodiment of the present invention, a payment banking network 101, processor network 103, or other network providing payment processor services includes a payment processing module (not shown) and a fee subsidy module (not shown). According to various embodiments, the payment processing module and fee subsidy module may be separate modules or combined in a single module and may reside on one or more servers within a network providing payment processing services.

The payment processing module is accessible by a user, such as a merchant, including retailers, wholesalers, or other persons or entities accepting a payments from customers, where the payment method used by the customers and accepted by the merchant is supported by the payment processing network. The payment processing module provides a services page to the user. According to one embodiment, the services page provides account information to the user, such as account status information and a services page element. Account status may include such information as a unique merchant identification, processing fees billed to the user, consumer transactions processed by the user, payments to the payment processor made by the user, payment to the user made by the payment processor, and rebate information regarding any activated opt-in program. In a further embodiment, the payment processing module creates a unique merchant identification upon the creation of a new user account.

The services page element provides access to a program page containing information regarding one or more opt-in programs, such as online advertising placement programs, keyword search services, online distribution services, loyalty services, or inventory and store data services, for example. The opt-in programs provide a method in which the user may receive rebates or subsidies in exchange for their participation in one or more of the available opt-in programs. In another embodiment, the unique merchant identification is provided to the program page for identifying a user when activating a particular program. The merchant identification is then returned to the fee subsidy module with reimbursement or other program information to ensure the accuracy of assigning any rebates to the correct user.

A user may review the opt-in programs available and follow any instructions associated with a particular opt-in program to sign-up for or participate in that particular program. According to one embodiment, the user selects a program by clicking or selecting a link associated with the program on the programs page. The user would then be provided with additional instructions for entering specific information, such as name, account information, or other identifying data.

The fee subsidy module receives instructions from the programs page. The instructions identify the opt-in program the user is participating in and includes information about the rebate to be awarded to the user. The information provided to the fee subsidy module may include a user's merchant identification, a description of the rebate or subsidy to be applied to the user's account, such as a fixed amount, a percentage of fees amount, or other specified amount, reimbursement information describing the payment method in which the payment processor is to be reimbursed for the rebate or subsidy provided to the user, and a payment for the rebate or subsidy provided to the user.

According to an embodiment of the present invention, service providers 170, such as Independent Software Vendors (“ISV”) and third-party service providers, interconnect with the payment network through a payment platform and provide an opt-in programs module (not shown) that includes an opt-in programs page providing various opt-in programs to the user. Payment platforms 102, 104, and 106 may also interconnect with the Internet to provide access to the payment services network 10. For example, a second retailer network 152 and business productivity software providers 153 are shown connecting to the payment services network 10 through the Internet 156.

In operation, a merchant from retailer network 105, for example, will have a user account with a payment processing provider for particular payment services, such as bank card processing. In one embodiment, the merchant's user account for payment processing services is identified with a merchant identification number. A merchant is typically assessed electronic processing fees when the merchant processes electronic payments with a bank card provider or other payment services provider. Such transactions are recorded by the payment processing provider to the merchant's user account for review by the merchant.

According to an embodiment of the present invention, a bank card provider is available through banking network 101 or payment processor network 103, for example. The bank card provider provides bank cards to bank card users. The bank card user may use their bank card with any merchant that has made an agreement with the bank card provider to allow the bank card to be used at the retailer's or merchant's locations.

The bank card provider typically assesses the merchant with various processing fees for transactions initiated with a bank card provided by the bank card provider. Processing fees assessed by the bank card provider may include interchange, discount rate and other ancillary fees, for example. These processing fees may be charged on a transaction and/or monthly basis.

The merchant may monitor transaction reporting information or other services information provided by the bank card provider by logging-in to a bank card provider services page, such as a webpage identified with a URL designated by the bank card provider, or other information source location. A services page may be accessible via a computer, phone, or other device configured to access the services page. According to one embodiment of the present invention, the bank card provider also provides online advertisement information from a third-party online advertising network within the bank card provider's services page. According to one embodiment, the third-party online advertising network is provided by one or more service providers from within service providers 170. The online advertisement information may be provided through text, images, or other web-page elements capable of directing a user to a third-party online advertising network's opt-in programs page.

According to a further embodiment of the present invention, the merchant may view the opt-in programs page by selecting a specified element of the advertisement information, such as clicking on a link, for example. The merchant is then directed to the opt-in programs page provided by the online advertising network where information regarding one or more programs or services available to the merchant is available. Programs or services available through the opt-in programs page may include online advertising placement programs, keyword search services, online distribution services, loyalty services, or inventory and store data services, for example. According to an embodiment of the present invention, a program or service made available to the merchant also provides an opportunity to reduce transaction costs paid by the merchant to the bank card provider through rebates or other program incentives.

According to one embodiment of the present invention, online advertising placement provides a merchant with the option of placing ads on their website and to receive a payment fee rebate on electronic payment processing when a new account with the third-party online advertising network is created from the merchant's website via a click-through transaction. In a further embodiment of the present invention, online advertising placement provides the merchant with an option of placing online ads on their website in exchange for receiving payment fee rebates on electronic payment processing.

In a further embodiment of the present invention, keyword search services provide the merchant keyword search services on a third party search engine and/or third party online advertising network in exchange for receiving payment fee rebates on electronic payment processing.

In another embodiment of the present invention, online distribution services provide the merchant the capability of publishing their inventory and/or content within an online marketplace in exchange for receiving payment fee rebates on electronic payment processing. In a further embodiment, this process may include accessing a payment interface on a merchant software application or point-of-sale to automatically and routinely pull inventory and/or content for publishing to the online marketplace.

In a further embodiment, loyalty services provide the merchant an opportunity to earn loyalty points through participation in various programs that can be used to receive payment fee rebates on electronic payment processing.

In another embodiment, inventory and store data services provide the merchant an opportunity to share store transactional meta-data for data analytics with a third-party online advertising network, direct marketing company, coupon provider, and/or online marketplace in exchange for payment fee rebates on electronic payment processing. In a further embodiment, this process may include accessing the payment interface on the merchant software application or point-of-sale to automatically and routinely push and pull data.

Once a merchant has agreed to participate in a service or program made available through the opt-in programs page, the bank card or payment services provider provides a rebate or other fee incentive to the merchant, thus reducing the fees charged by the payment processor to the merchant. The reduction in fees may be a fixed amount, a percentage of the total or incremental subset of the electronic payment processing fees, or some other amount based on the program in which the merchant has agreed to participate.

The third-party online advertising network providing the services will in turn provide compensation to the bank card or payment services provider according to terms established between the third-party online advertising network and the bank card or payment services provider for the service in which the merchant is participating. In a further embodiment, the merchant may participate in multiple programs, thus further reducing the electronic payment processing fees assed to the merchant.

In a further embodiment of the present invention, when a merchant agrees to participate in a opt-in program, a user account is created and the user's merchant identification is maintained with the user's account for purposes of processing reimbursement payments from the online advertising network to the bank card or payment processing provider.

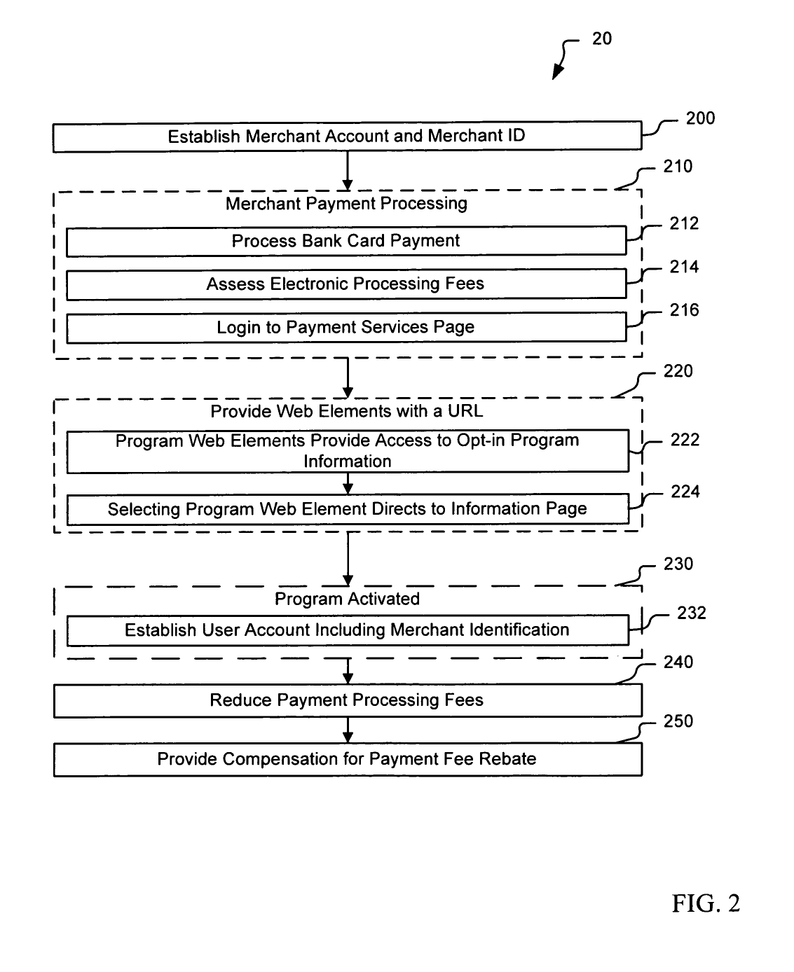

FIG. 2 shows a method for subsidizing payment transaction costs through online advertising, according to an embodiment of the present invention. The method for subsidizing payment transaction costs begins with a merchant establishing a merchant account and merchant identification with a bank card or payment services provider at step 200. The method continues with payment process 210. Payment process 210 begins at step 212 when a payment is made through a payment processor's method of payment, such as a bank card or other online payment option. At step 214, processing fees are assessed. At step 216, transaction reporting metrics are reviewed by logging in to a payment services page. In a further embodiment, other service portals may also be accessed through the payment services page.

Process 220 provides the inclusion of web elements within the payment services page. Web elements may include text, graphics, programmable features, or other page elements provided through html or other web-page creation mechanisms. At step 222, program web elements provide information and redirection capabilities to an opt-in program page in which a user may review opt-in programs and other information available to the user. At step 224, the web-element providing redirection to the opt-in program page is selected and the user is redirected to the opt-in program page.

The opt-in program page may include online advertising placement services, keyword search services, online distribution services, loyalty services, or inventory and store data services, for example. Within the opt-in programs page, the user may review information regarding the programs available or select web-elements redirecting the user to more specific information regarding a particular program. At step 230, a program from the available opt-in program page is activated, wherein the user establishes a user account incorporating the user's merchant identification at agrees to the terms of the particular program at step 232.

Once a program is activated and the user acts in accordance with the activated program, payment processing fees are reduced for the merchant account associated with the merchant identification incorporated with the user account at step 240 in the form of a rebate or other fee reduction in accordance with the program activated by the user. At step 250, compensation is paid to cover the rebate or other fee reduction. For example, a payment processing entity reduces a merchant's processing fees by a specified amount as instructed by the online advertising network. In turn, the online advertising network reimburses the payment processing entity for the specified amount.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

What is claimed is:

1. A method for subsidizing a user's payment transaction costs, comprising the steps of:
providing a services page containing a user's account status information;
providing a services page element for directing the user to a program page containing an opt-in program; and
reducing a user's payment processing fees based on an activated opt-in programs terms.

2. The method of claim 1, wherein the user's account status information further includes unique transaction reporting metrics.

3. The method of claim 1, further comprising the steps of:
providing a user identification to the user by a payment processing provider; and
establishing a user account with a third-party online advertising network that is correlated with the user identification for the purpose of compensating the payment processing provider by the third-party online advertising network.

4. The method of claim 1, wherein the step of providing a services page containing a user's account status information further comprises the step of providing one or more electronic payment services provider service portals.

5. The method of claim 1, further comprising the step of receiving compensation from an opt-in program provider for reducing the user's payment processing fees.

6. The method of claim 1, further comprising the step of providing an opt-in program within the program page.

7. The method of claim 6, wherein the step of providing an opt-in program further comprises providing an online advertising placement program, wherein a merchant places ads on their website in exchange for a payment fee rebate on electronic payment processing when a new account with a third party online advertising network is created from the merchant's website via a click-through process.

8. The method of claim 6, wherein the step of providing an opt-in program further comprises providing an online advertising placement program, wherein the merchant places online ads on their website in exchange for receiving a payment fee rebate on electronic payment processing.

9. The method of claim 6, wherein the step of providing an opt-in program further comprises providing a keyword search service, wherein the merchant uses keyword search services on a third party search engine in exchange for receiving a payment fee rebate on electronic payment processing.

10. The method of claim 6, wherein the step of providing an opt-in program further comprises providing an a keyword search service, wherein the merchant uses keyword search services on a third party online advertising network in exchange for receiving a payment fee rebate on electronic payment processing.

11. The method of claim 6, wherein the step of providing an opt-in program further comprises providing online distribution services, wherein the merchant publishes the merchant's inventory to a third-party marketplace in exchange for receiving a payment fee rebate on electronic payment processing.

12. The method of claim 11, further comprising the step of accessing the payment interface on a merchant software application for pulling inventory for publishing to the third-party marketplace.

13. The method of claim 11, further comprising the step of accessing the payment interface on a merchant software application for pulling content for publishing to the third-party marketplace.

14. The method of claim 6, wherein the step of providing an opt-in program further comprises providing loyalty services, wherein the merchant earns loyalty points through participation in various programs; and that can be used to receive payment fee rebates on electronic payment processing.

15. The method of claim 6, wherein the step of providing an opt-in program further comprises providing an inventory and store data program, wherein the merchant provides transactional meta-data for use in data analytics to a third party in exchange for receiving payment fee rebates on electronic payment processing.

16. The method of claim 15, further comprising the step of accessing a payment interface within a merchant's software application to pull the transactional meta-data.

17. The method of claim 1, wherein the step of reducing a user's payment processing fees based on an activated opt-in program's terms further comprises reducing the user's payment processing fees assessed by a payment processor.

18. The method of claim 17, wherein the step of reducing the user's payment processing fees assessed by a payment processor further comprises reducing the user's payment processing fees by a fixed amount

19. The method of claim 17, wherein the step of reducing the user's payment processing fees assessed by a payment processor further comprises reducing the user's payment processing fees by a percentage amount.

20. The method of claim 17, further comprising the step of reimbursing the payment processor for the reduction in payment processing fees.

21. The method of claim 17, further comprising the step of reimbursing the payment processor for the reduction in payment processing fees of a net rebate.

22. The method of claim 17, further comprising the step of displaying the reduction in fees within the user's account status information of the services page.

23. A system for subsidizing a user's payment transaction costs, comprising:
a payment processing module accessible by a user, the payment processing module provides a services page to the user containing the user's account status information and a services page element for directing the user to a program page containing information regarding one or more opt-in programs; and
a fee subsidy module for receiving instructions to reduce a user's payment processing fees based on terms of an activated opt-in program.

24. The system of claim 23, wherein the user's account status information includes at least one of:
a merchant identification;
processing fees billed to the user;
consumer transactions processed by the user;
payments to the payment processor made by the user;
payment to the user made by the payment processor; and
rebate information regarding any activated opt-in program.

25. The system of claim 23, wherein the instructions to reduce a user's payment processing fees includes at least one of:
a user's merchant identification;
a description of the rebate or subsidy to be applied to the user's account;
reimbursement information describing the payment method in which the payment processor is to be reimbursed for the rebate or subsidy provided to the user; and
a reimbursement payment for the rebate or subsidy provided to the user.

26. The system of claim 23, wherein the payment processing fees is at least one of
a fixed amount; and
a percentage of fees amount.

27. The system of claim 23, further comprising an opt-in programs module for providing the program page and creating an opt-in user's account when a user agrees to participate in an opt-in program.

28. The system of claim 27, wherein the payments processing module further creates a unique merchant identification upon the creation of a user's account.

29. The system of claim 28, wherein the opt-in programs module assigns the unique merchant identification to the opt-in user's account.

30. The system of claim 29, wherein the opt-in program module returns the unique merchant identification to the fee subsidy module with the instructions for reducing a user's payment processing fees.
